(19) United States
(12) Patent Application Publication
(10) Pub. No.: US 2025/0355963 A1
(43) Pub. Date: Nov. 20, 2025

(54) THIRD-PARTY PRIVATE SET INTERSECTION FOR MULTIPLE INPUT PARTIES

(71) Applicant: Seagate Technology LLC, Fremont, CA (US)

(72) Inventors: Foo Yee YEO, Shugart (SG); Jason Hwei Ming YING, Shugart (SG)

(21) Appl. No.: 19/210,588

(22) Filed: May 16, 2025

Related U.S. Application Data
(60) Provisional application No. 63/649,260, filed on May 17, 2024.

(51) Int. Cl. G06F 17/11; G06F 7/58

(52) U.S. Cl. CPC G06F 17/11; G06F 7/582

(57) ABSTRACT

A method computes, by a third party, a private set intersection of datasets of multiple input parties, wherein each dataset includes one or more data elements. The computer-processor-implemented method includes: obtaining one or more share polynomials for each dataset of the multiple input parties, the one or more share polynomials for a dataset of an input party being encoded from shares of zero for the input party, each share of zero corresponding to a data element of the dataset of the input party; determining an intersection polynomial based on the one or more share polynomials; and determining the private set intersection of the datasets to include data elements of the datasets of the multiple input parties for which the intersection polynomial of the multiple input parties solves to zero.

### CLAIM OF PRIORITY AND CROSS-REFERENCE TO RELATED APPLICATION

The present application claims benefit of priority to U.S. Provisional Patent Application No. 63/649,260, entitled “Third-Party Private Set Intersection for Multiple Input Parties” and filed on May 17, 2024, which is specifically incorporated herein by reference for all that it discloses and teaches.

### SUMMARY

In some aspects, the techniques described herein relate to a computer-processor-implemented method of computing, by a third party, a private set intersection of datasets of multiple input parties, wherein each dataset includes one or more data elements, the computer-processor-implemented method including: obtaining one or more share polynomials for each dataset of the multiple input parties, the one or more share polynomials for a dataset of an input party being encoded from shares of zero for the input party, each share of zero corresponding to a data element of the dataset of the input party; determining an intersection polynomial based on the one or more share polynomials; and determining the private set intersection of the datasets to include data elements of the datasets of the multiple input parties for which the intersection polynomial of the multiple input parties solves to zero.

In some aspects, the techniques described herein relate to a computing system corresponding to a third party for computing a private set intersection of datasets of multiple input parties, wherein each dataset includes one or more data elements, the computing system including: one or more hardware processors; memory; a share of zero processor storable in memory, executable by the one or more hardware processors, and configured to obtain one or more share polynomials for each dataset of the multiple input parties, the one or more share polynomials for a dataset of an input party being encoded from shares of zero for the input party, each share of zero corresponding to a data element of the dataset of the input party; an intersection polynomial generator storable in memory, executable by the one or more hardware processors, and configured to determine an intersection polynomial based on the one or more share polynomials; and an intersection solver storable in memory, executable by the one or more hardware processors, and configured to determine the private set intersection of the datasets to include data elements of the datasets of the multiple input parties for which the intersection polynomial of the multiple input parties solves to zero.

In some aspects, the techniques described herein relate to one or more tangible processor-readable storage media embodied with instructions for executing on one or more processors and circuits of a computing device a process for computing, by a third party, a private set intersection of datasets of multiple input parties, wherein each dataset includes one or more data elements, the process including: obtaining one or more share polynomials for each dataset of the multiple input parties, the one or more share polynomials for a dataset of an input party being encoded from shares of zero for the input party, each share of zero corresponding to a data element of the dataset of the input party; determining an intersection polynomial based on the one or more share polynomials; and determining the private set intersection of the datasets to include data elements of the datasets of the multiple input parties for which the intersection polynomial of the multiple input parties solves to zero.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system for computing a private set intersection of datasets of multiple input parties.

FIG. 2 illustrates an example private intersection detector system for computing a private set intersection of datasets of multiple input parties (see, e.g., input party, input party, and input party).

FIG. 3 illustrates example operations for computing a private set intersection of datasets of multiple input parties.

FIG. 4 illustrates an example computing device for use in implementing the described technology.

### DETAILED DESCRIPTIONS

The described technology provides third-party private set intersection (PSI) for two or more input parties: given two or more input datasets S₁, . . . , S_{N} held by N different input parties P₁, . . . , P_{N}, the described technology securely computes the intersection of these datasets and privately reveals the result to an inputless third-party Q. Accordingly, the third-party PSI technology described herein can be summarized as follows: a cryptographic protocol that allows two or more input parties P₁, . . . , P_{N} to have a third party compute the intersection of their respective datasets S₁, . . . , S_{N} without revealing any additional information to each other. A distinction in third-party PSI is that the intersection result is revealed only to an independent third party Q. This approach is useful in scenarios where a neutral entity (e.g., the third party Q) needs to analyze shared data without exposing one input party's individual dataset to other input parties. Implementations of third party PSI can be useful in cybersecurity threat detection, product support, marketing analytics, medical research, etc.

There are numerous applications for multi-party third-party PSI. A potential use case arises when a hardware vendor seeks to periodically gather some data from two or more enterprise customers on the status of the vendor's hard drives to better conduct analytics on performance. In this setting, the vendor assumes the role of Q, the enterprise customers assume the role of Pᵢ, and Sᵢ correspond to the models of hard drives held by Pᵢ that have drive log readings exceeding a threshold within a given timeframe. The described multi-party third-party PSI enables the vendor to obtain, in a privacy-preserving manner, the required list for the models of hard drives sold to a group of enterprise customers, all of which have drive log readings exceeding a threshold within a timeframe of interest.

Multi-party third party PSI can be applied as a solution to cybersecurity issues, such as the identification of an intruder in a common network of organizations. The cybersecurity authority plays the role of the third party, while the organizations are the input party participants, each of which holds a list of suspicious IP addresses. As such, using multi-party third party PSI, the cybersecurity authority is able to narrow down the intersection output while preserving the privacy of other IP addresses held by each organization.

Another use case application arises in marketing, whereby a group of shop owners intends to collaboratively launch a promotional campaign. The participating input parties are the shop owners, each of whom has a list of customers, while the marketing agency is the third party. The marketing agency is able to obtain the list of common customers to target from the intersection, and the shop owners maintain the confidentiality of their customers from the rest of the competitors.

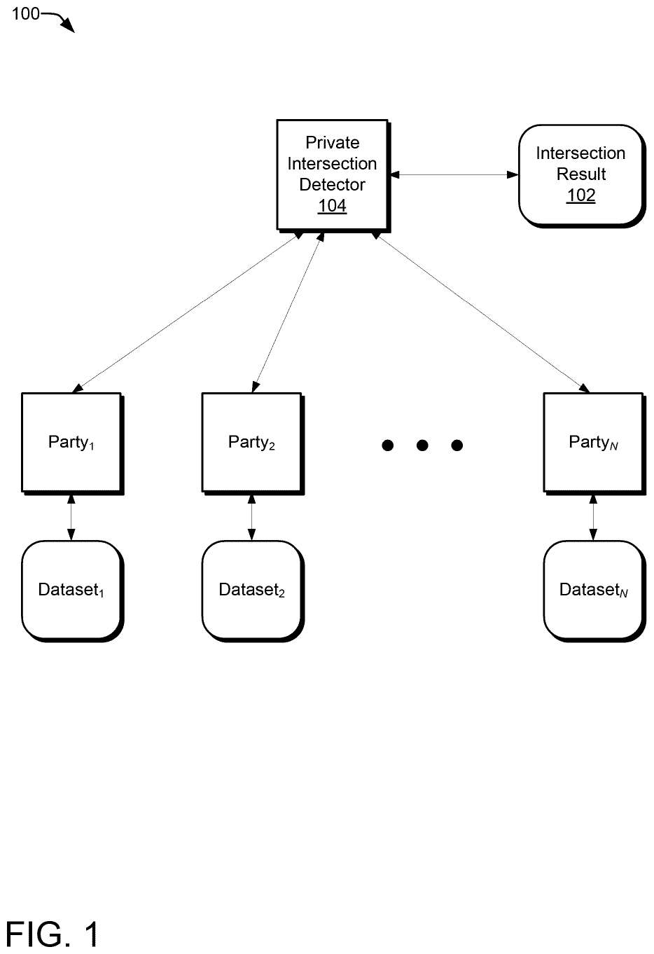

FIG. 1 illustrates an example system 100 for computing a private set intersection of datasets of multiple input parties. The multiple parties are identified in FIG. 1 as Party₁, Party₂, . . . , Party_{N} (also identified herein as P₁, P₂, . . . , P_{N}). The datasets of these parties are identified as Dataset₁, Dataset₂, . . . , Dataset_{N} (also identified herein as S₁, S₂, . . . , S_{N}), with data elements of these datasets being identified using a lowercase s. A third party system (also denoted as Q) that computes the private set intersection result 102 is identified as the private intersection detector 104.

The described technology includes at least two implementations for multi-party third-party PSI. A first implementation relies on combining a zero-sharing technique with a technique of encoding intersection data elements into a share polynomial and summing multiple share polynomials into an intersection polynomial that can be solved to determine the private set intersection. A second implementation allows a private intersection detector to cheaply obtain a polynomial that splits into distinct linear factors, each linear factor corresponding to an intersection data element.

Aspects of the described technology provide multi-party third-party PSI for two or more input parties (the number of input parties is denoted as N) and are secure in the semi-honest model against any number of corrupt parties. Generally, a semi-honest model refers to a security model used to analyze and design cryptographic protocols. In this model, it is assumed that all parties involved in the protocol strictly follow the protocol's rules as specified, but these parties may try to learn additional information from the data they receive during the execution of the protocol. As such, while following the protocol, parties may attempt to infer additional information from the data they receive. The protocol is designed to ensure that even if parties try to learn more than they should, they cannot gain any information beyond what is allowed by the protocol.

A first implementation, corresponding to a first protocol, combines a zero-sharing technique with a technique of encoding intersection data elements into a share polynomial p. Generally, the input parties create shares of zero for each data element in their datasets. A “share of zero” refers to a value computed by each input party in a multi-party protocol, such that when the shares of zero of an input party are summed together, the values cancel out to zero. This technique is used to securely compute the intersection of datasets held by different input parties without revealing the dataset of one input party to the other input parties. Each input party generates these shares of zero values using a pseudorandom function (PRF) and shared pseudorandom keys, ensuring that the sum of the share of zero values for a data element in the intersection is zero, while the sum for data elements not in the intersection is non-zero. These shares of zero values are generated using the pseudorandom function F. Each input party Pᵢ then encodes its shares of zero (corresponding to data elements in the dataset) into a share polynomial pᵢ at the point s (representing a data element in a dataset). These share polynomials are then sent to the private intersection detector 104 (Q), which can use them to determine the intersection of the data elements of the datasets of the input parties.

The first implementation includes generating shares of zero for each data element in the datasets of the input parties. A PRF F is fixed. Each party Pᵢ generates a unique PRF key k_{i,j} for every other party Pⱼ, where 1≤i, j≤N and i+j, using the fixed PRF F. Each input party Pᵢ shares its generated PRF keys with the corresponding input parties, such that each input party Pᵢ has knowledge of the PRF keys k_{i,j} and k_{j,i} for any j (e.g., if there are N=4 input parties, then P₃ knows the keys k_{3,1}, k_{3,2}, k_{3,4}, k_{1,3}, k_{2,3}, k_{4,3}). This approach allows each input party Pᵢ to compute the share of zero:

$${\sum }_{j = 1 , j \neq i}^{n} ( F ( {k}_{i , j} , s ) - F ( {k}_{j , i} , s ) )$$

for each data element s in the dataset Sᵢ of the input party Pᵢ . In the above example, if s lies in the intersection of all datasets, then P₁, P₂, P₃, and P₄ will compute

$${Share}_{{P}_{1}} = F ( {k}_{1 , 2} , s ) + F ( {k}_{1 , 3} , s ) + F ( {k}_{1 , 4} , s ) - F ( {k}_{2 , 1} , s ) - F ( {k}_{3 , 1} , s ) - F ( {k}_{4 , 1} , s ) ,$$

$${Share}_{{P}_{2}} = F ( {k}_{2 , 1} , s ) + F ( {k}_{2 , 3} , s ) + F ( {k}_{2 , 4} , s ) - F ( {k}_{1 , 2} , s ) - F ( {k}_{3 , 2} , s ) - F ( {k}_{4 , 2} , s ) ,$$

$${Share}_{{P}_{3}} = F ( {k}_{3 , 1} , s ) + F ( {k}_{3 , 2} , s ) + F ( {k}_{3 , 4} , s ) - F ( {k}_{1 , 3} , s ) - F ( {k}_{2 , 3} , s ) - F ( {k}_{4 , 3} , s ) ,$$

$${Share}_{{P}_{4}} = F ( {k}_{4 , 1} , s ) + F ( {k}_{4 , 2} , s ) + F ( {k}_{4 , 3} , s ) - F ( {k}_{1 , 4} , s ) - F ( {k}_{2 , 4} , s ) - F ( {k}_{3 , 4} , s ) ,$$

respectively. Observe that these shares do indeed sum to 0.

After each input party has generated the shares of zero for the data elements in its dataset, the input party encodes its shares of zero into a share polynomial, which it provides to the private intersection detector 104. As such, each input party Pᵢ will encode its share of zero corresponding to an element s (assuming that s lies in its dataset Sᵢ) in a share polynomial pᵢ at the point s. Therefore, if an element s lies in the intersection of all the datasets S₁, . . . , S_{N}, all parties Pᵢ will have encoded their share of zero (corresponding to the element s) into their share polynomial pᵢ. This means that the sum of these share polynomials p₁+ . . . +p_{N} has a value of 0 when evaluated at s. However, if s does not lie in the intersection of all datasets, some input party Pᵢ will not have encoded its share of zero (corresponding to the element s) into its share polynomial pᵢ. This means that p₁+ . . . +p_{N} now has a pseudorandom value when evaluated at s and is hence non-zero with high probability, thereby indicating that s does not lie in the intersection of all the datasets. The private intersection detector 104 (Q), therefore, determines the intersection data elements among the input parties by finding all data elements s for which the equation p₁(s)+ . . . +p_{N}(s)=0.

While the solution as presented above is secure in the semi-honest model against any single corrupt party, it might not be secure against certain collusions of parties that include Q. To obtain a protocol that is secure against collusions of any subset of parties, each Pᵢ can only obtain at most n evaluations of F under the key k_{j,k} (where n is the size of each dataset Sᵢ). This constraint is achieved with the use of an oblivious PRF (OPRF). There are two parties in an oblivious PRF protocol: a sender S with a key, and a receiver R who holds a private input. An OPRF allows R to obtain an evaluation of the PRF, without S learning the input or R learning the key. This change makes both the first protocol and the second protocol secure against any collusion and is an example implementation of the protocol, although other implementations may be employed.

Suppose there are N parties P₁, . . . , P_{N}, each with a dataset Sᵢ⊆{0,1 [symbol] e of size n. Let λ>0 be the correctness parameter and let F be a finite field with | [symbol] |> [symbol] . We fix an injective map: {0,1 [symbol] [symbol] with image S, fix some a₀∈ [symbol] \S and let F: [symbol] ×S→ [symbol] be a PRF. For ease of notation, we shall implicitly identify {0,1 [symbol] with its image S⊆ [symbol] F under the map t. Furthermore, let

$${ℱ}_{OPRF}^{F}$$

be an OPRF protocol for F.
1. For each i, j∈[N] with j≠i, Pᵢ generates a key k_{i,j}∈ [symbol] .
2. For each i, j∈[N] with j≠i, and each s∈Sⱼ, Pᵢ and Pⱼ invoke

$${ℱ}_{OPRF}^{F}$$

where
Pᵢ is a sender with input k_{i,j},
Pⱼ is a receiver with input s.
3. For i∈[N], Pᵢ picks a random rᵢ← [symbol] , computes the share polynomial pᵢ(X) of degree≤n such that pᵢ(a₀)=rᵢ

$${p}_{i} ( s ) = {\sum }_{j ∈ [ N ] \backslash \{ i \}}^{n} ( F ( {k}_{i , j} , s ) - F ( {k}_{j , i} , s ) )$$

for all s∈Sᵢ, and sends pᵢ(X) to Q.
4. Q solves

$${\sum }_{i = 1}^{N} {p}_{i} ( X ) = 0 ,$$

wherein

$${\sum }_{i = 1}^{N} {p}_{i} ( X )$$

referred to as an intersection polynomial) and outputs

$$\{ s ∈ S : {\sum }_{i = 1}^{N} {p}_{i} ( s ) = 0 \} .$$

While the first protocol has a communication complexity that is linear in n, its computational complexity is significantly higher at O(n^{1.5+o(1)}). A second example implementation, according to a second protocol, further improves the first protocol to achieve a linear computational complexity for the parties Pᵢ and a quasilinear computational complexity for Q.

Recall that, in the first implementation, Q uses the information obtained from the input parties Pᵢ to form a share polynomial that has roots at the intersection elements. However, this share polynomial is of degree n and thus has other irreducible factors, which are almost always non-linear. Finding the roots of such a share polynomial is significantly more costly than finding the roots of a share polynomial that splits into distinct linear factors.

Therefore, a second protocol is introduced that allows Q to cheaply obtain a share polynomial that splits into distinct linear factors, each linear factor corresponding to an intersection element. This approach allows Q to use an algorithm for equal-degree factorization in the last step of the protocol, hence achieving a quasilinear computational complexity by allowing Q to obtain two different random polynomials q₁ and q₂, both of which have roots at the intersection elements. Equal-degree factorization is a technique used in polynomial factorization, particularly over finite fields, which generally involves decomposing a share polynomial into factors where each factor has the same degree.

By taking the greatest common divisor of q₁ and q₂ (the greatest common divisor or GCD can be computed in quasilinear time), Q then obtains a polynomial q(X) that has no extraneous factors and thus can be solved in quasilinear time. In one implementation, the Euclidean algorithm is a highly efficient method for finding the GCD of two polynomials, although other techniques may be employed. The Euclidean algorithm is based on the principle that the GCD of two polynomials also divides their difference.
Initial Setup: Let q₁ and q₂ be the two polynomials with deg(q₁)≥deg(q₂).
Division: Divide q₁ by q₂ to obtain a quotient Q₁ and a remainder R₁, such that q₁=Q₁·q₂+R₁, with deg(R₁)<deg(q₂).
Iteration: Replace q₁ with q₂ and q₂ with R₁. Repeat the division process to obtain a quotient Q₂ and a remainder R₂, such that q₂=Q₂·R₁+R₂, with deg(R₂)<deg(R₁). Continue this process iteratively until the remainder R is zero. The last non-zero remainder R is the GCD of q₁ and q₂.

A similar setup as presented in the previous section is performed, but replacing F with a PRF F: [symbol] ×S→ [symbol] . Let πᵢ: [symbol] → [symbol] (for i=1,2) be the projection onto the i-th coordinate, and let Fᵢ=πᵢ·F. F. As before, we let

$${ℱ}_{OPRF}^{F}$$

be an OPRF protocol for F.
1. For each i, j∈[N] with j≠i, Pᵢ generates a key k_{i,j}∈ [symbol] .
2. For each i, j∈[N] with j≠i, and each s∈Sⱼ, Pᵢ and Pⱼ invoke

$${ℱ}_{OPRF}^{F}$$

where
Pᵢ is a sender with input k_{i,j},
Pⱼ is a receiver with input s.
3. For i∈[N], Pᵢ picks random r_{i,1}, r_{i,2}← [symbol] , and computes the share polynomials p_{i,1}(X) and p_{i,2}(X), each of degree≤n, such that p_{i,h}(a₀)=r_{i,h} and

$${p}_{i , h} ( s ) = {\sum }_{j ∈ [ N ] ∖ \{ i \}} ( {F}_{h} ( {k}_{i , j} , s ) - {F}_{h} ( {k}_{j , i} , s ) )$$

for all s∈Sᵢ, and sends share polynomials p_{i,1}(X) and p_{i,2}(X) to Q.
4. Q computes the intersection polynomial q(X) as:

$$q ( X ) = g c d ( {\sum }_{i = 1}^{N} {p}_{i , 1} ( X ) , {\sum }_{i = 1}^{N} {p}_{i , 2} ( X ) )$$

where

$${q}_{1} = {\sum }_{i = 1}^{N} {p}_{i , 1} ( X ) and {q}_{2} = {\sum }_{i = 1}^{N} {p}_{i , 2} ( X ) ,$$

both of which are referred to as summed polynomials.
5. Q factorizes the intersection polynomial q(X) into linear factors using equal-degree factorization (e.g., solving for q(s)=0) and outputs {s∈S: q(s)=0}.

In summary, aspects of the described technology provide two different (but related) protocol implementations that solve the multi-party PSI problem in the third party setting. The advantages of the protocols may include:
1. the protocols are the first solutions to the multi-party third party PSI problem, and
2. the protocols are secure against collusions of any subset of parties.

The first protocol requires less communication overall and also has lower computational costs for the parties Pᵢ compared to the second protocol. The second protocol, however, is overall much more computationally efficient since it greatly reduces the computational costs for Q (at the expense of slightly higher computational costs for the parties Pᵢ). Hence, both protocols can be useful in practice, depending on the specific use case.

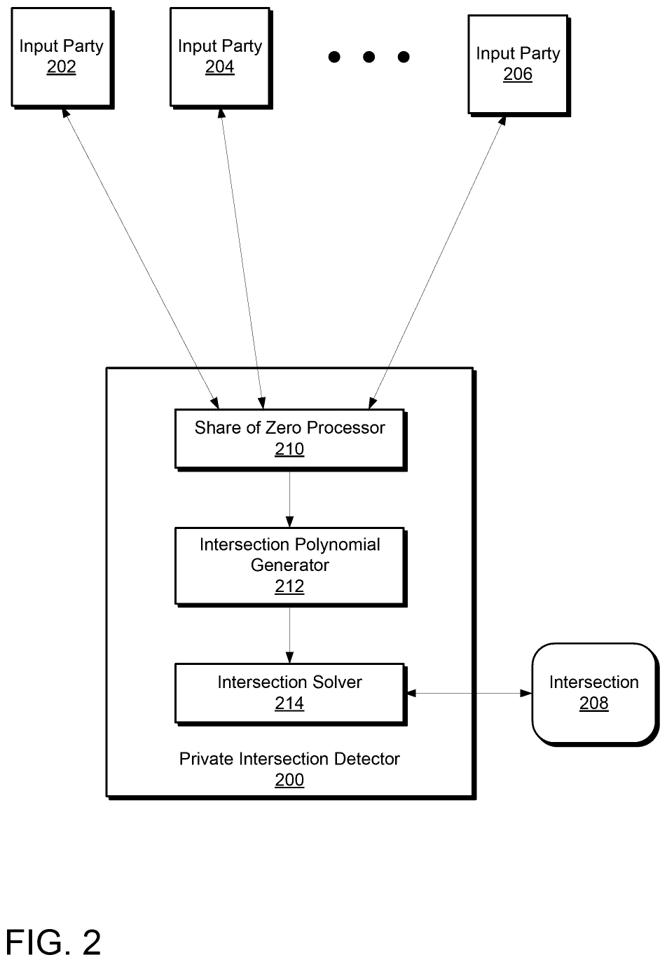

FIG. 2 illustrates an example private intersection detector system 200 for computing a private set intersection of datasets of multiple input parties (see, e.g., input party 202, input party 204, and input party 206). Each dataset includes one or more data elements, and the private intersection detector system 200 detects and outputs an intersection 208 of data elements from these datasets (e.g., the data elements that exist in all of the datasets).

A share of zero processor 210 obtains one or more share polynomials for each dataset of the multiple input parties. The one or more share polynomials for a dataset of an input party are encoded from shares of zero for the input party. Each share polynomial corresponds to a data element of the dataset of the input party. In some implementations, each share polynomial of an input party includes a constant term randomly selected by the input party.

In one implementation, according to the first protocol, a share polynomial for each dataset is received by the share of zero processor 210 from the corresponding input party. In some aspects, the share of zero for each data element of a dataset of an input party is computed based on pseudorandom function keys corresponding to pairs of distinct input parties of the multiple input parties. Each pseudorandom function key is unique relative to the other pseudorandom function keys. In some implementations, a pseudorandom function key is shared from a sending input party to a receiving input party. In other implementations (e.g., implementations employing oblivious PRFs), the pseudorandom function keys are not shared between input parties. In other aspects, the share of zero for each data element in the dataset of an input party is computed by the input party as a sum of evaluations of a pseudorandom function at the data element and each pseudorandom function key for which it is the sending input party minus a sum of evaluations of a pseudorandom function at the data element and each pseudorandom function keys for which it is the receiving input party. In other implementations (e.g., implementations employing oblivious PRFs), the pseudorandom function keys are not shared between input parties.

In another implementation, according to the second protocol, the share of zero processor 210 receives, from each input party of the multiple input parties, a first share polynomial for each dataset of the input party and a second share polynomial for each dataset of the input party. In some implementations, more than two share polynomials may be received. The share of zero processor 210 uses the first share polynomial and the second polynomial to compute the intersection polynomial as the greatest common divisor of the sum of the first share polynomials and the sum of the second share polynomials and to factorize the intersection polynomial into linear factors using equal-degree factorization. In some implementations, the first and second share polynomials of an input party each include a constant term randomly selected by the input party. In this manner, the share of zero processor 210 generates an intersection polynomial based on the first and second share polynomials received from the input parties.

An intersection polynomial generator 212 receives the one or more share polynomials corresponding to each of the input parties from the share of zero processor 210 and determines an intersection polynomial based on the one or more share polynomials. In one implementation, according to the first protocol, the intersection polynomial generator 212 yields the intersection polynomial as

$${\sum }_{i = 1}^{N} {p}_{i} ( X ) .$$

According to the second protocol, the intersection polynomial generator 212 yields the intersection polynomial as

$$q ( X ) = g c d ( {\sum }_{i = 1}^{N} {p}_{i , 1} ( X ) , {\sum }_{i = 1}^{N} {p}_{i , 2} ( X ) ) .$$

Other implementations may vary.

An intersection solver 214 determines the private set intersection of the datasets to include data elements of the datasets of the multiple input parties for which the intersection polynomial of the multiple input parties solves to zero (e.g., Q solves

$${\sum }_{i = 1}^{N} {p}_{i} ( X ) = 0$$

and outputs

$$\{ s ∈ S : {\sum }_{i = 1}^{N} {p}_{i} ( s ) = 0 \} ) .$$

In another implementation, according to the second protocol, the intersection polynomial generator 212 generates the intersection polynomial as the greatest common divisor of a sum of the first share polynomials of each input party and a sum of the second share polynomials of each input party. For example, Q can compute the intersection polynomial

$$q ( X ) = g c d ( {\sum }_{i = 1}^{N} {p}_{i , 1} ( X ) , {\sum }_{i = 1}^{N} {p}_{i , 2} ( X ) ) .$$

The intersection solver 214 factorizes that intersection polynomial q(X) into linear factors using equal-degree factorization (e.g., solving q(s)=0) and outputs {s∈S: q(s)=0}.

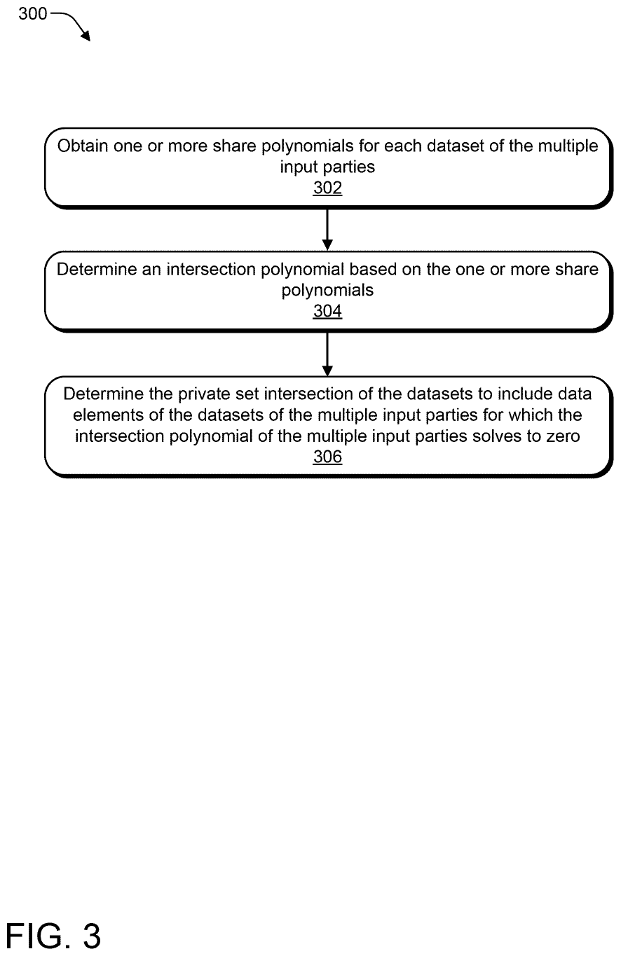

FIG. 3 illustrates example operations 300 for computing a private set intersection of datasets of multiple input parties. Each dataset includes one or more data elements. The operations 300 are performed by a third party, such that the private set intersection results and respective data elements remain private among the input parties.

An obtaining operation 302 obtains one or more share polynomials for each dataset of the multiple input parties. The one or more share polynomials for a dataset of an input party are encoded from shares of zero for the input party. Each share of zero corresponds to a data element of the dataset of the input party. In one implementation, the share polynomial for each dataset is received by the obtaining operation 302 from the corresponding input party. In some aspects, the share of zero for each data element of a dataset of an input party is computed based on pseudorandom function keys corresponding to pairs of distinct input parties of the multiple input parties. Each pseudorandom function key is unique relative to the other pseudorandom function keys and is shared from a sending input party to a receiving input party. In other aspects, the share of zero for each data element in the dataset of an input party is computed by the input party as a sum of evaluations of a pseudorandom function at the data element and each pseudorandom function keys for which it is the sending input party minus a sum of evaluations of a pseudorandom function at the data element and each pseudorandom function keys for which it is the receiving input party. Some implementations may employ oblivious PRFs, in a manner discussed previously.

In another implementation, the share of zero processor receives, from each input party of the multiple input parties, a first polynomial for each dataset of the input party and a second polynomial for each dataset of the input party. The obtaining operation 302 uses the first polynomial and the second polynomial to compute the share polynomial as the greatest common divisor of the first polynomial and the second polynomial and to factorize the share polynomial into linear factors using equal-degree factorization. In some implementations, the first and second polynomials of an input party each include a constant term randomly selected by the input party. In this manner, the obtaining operation 302 generates share polynomials for each dataset based on the first and second polynomials received from the input parties.

A determining operation 304 determines an intersection polynomial based on the one or more share polynomials. According to the first protocol, the determining operation 304 yields the intersection polynomial as

$${\sum }_{i = 1}^{N} {p}_{i} ( X ) .$$

According to the second protocol, the determining operation 304 yields the intersection polynomial as

$$q ( X ) = g c d ( {\sum }_{i = 1}^{N} {p}_{i , 1} ( X ) , {\sum }_{i = 1}^{N} {p}_{i , 2} ( X ) ) .$$

Other implementations may vary.

Another determining operation 306 determines the private set intersection of the datasets to include data elements of the datasets of the multiple input parties for which the intersection polynomial of the multiple input parties evaluated at the data element solves to zero.

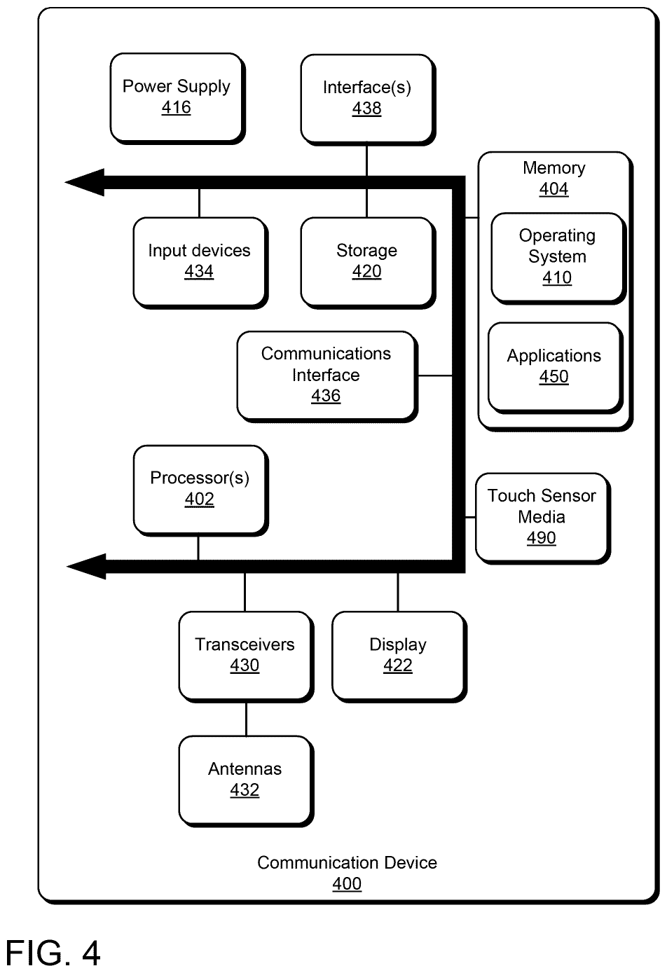

FIG. 4 illustrates an example computing device 400 for use in implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes one or more hardware processor(s) 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processor(s) 402. In some implementations, the computing device 400 includes and/or is communicatively coupled to storage 420.

In the example computing device 400, as shown in FIG. 4, one or more software modules, segments, and/or processors, such as applications 450, a private intersection detector, a share of zero processor, a share polynomial evaluator, an intersection solver, software executing the roles of the input parties and/or the third-party, and other program code and modules are loaded into the operating system 410 on the memory 404 and/or the storage 420 and executed by the processor(s) 402. The storage 420 may store datasets, data elements, intersections of datasets, cryptographic keys, pseudorandom keys, shares of zero, share polynomials, intersection polynomials, pseudorandom functions, and other data and be local to the computing device 400 or may be remote and communicatively connected to the computing device 400. In particular, in one implementation, components of a system for computing third-party private set intersection for multiple input parties may be implemented entirely in hardware or in a combination of hardware circuitry and software.

The computing device 400 includes a power supply 416, which may include or be connected to one or more batteries or other power sources, and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices). The computing device 400 may use the adapter and any other types of communication devices for establishing connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display (see, e.g., touch sensor media 490).

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computer-processor-implemented method of computing, by a third party, a private set intersection of datasets of multiple input parties, wherein each dataset includes one or more data elements, the computer-processor-implemented method comprising:
obtaining one or more share polynomials for each dataset of the multiple input parties, the one or more share polynomials for a dataset of an input party being encoded from shares of zero for the input party, each share of zero corresponding to a data element of the dataset of the input party;
determining an intersection polynomial based on the one or more share polynomials; and
determining the private set intersection of the datasets to include data elements of the datasets of the multiple input parties for which the intersection polynomial of the multiple input parties solves to zero.

2. The computer-processor-implemented method of claim 1, wherein the share of zero for each data element of a dataset of an input party is computed based on pseudorandom function keys corresponding to pairs of distinct input parties of the multiple input parties, each pseudorandom function key being unique relative to other pseudorandom function keys of the multiple input parties and being shared from a sending input party to a receiving input party.

3. The computer-processor-implemented method of claim 2, wherein the share of zero for each data element in the dataset of an input party is computed by the input party as a sum of evaluations of a pseudorandom function at the data element and each pseudorandom function keys for which it is the sending input party minus a sum of evaluations of a pseudorandom function at the data element and each pseudorandom function keys for which it is the receiving input party.

4. The computer-processor-implemented method of claim 3, wherein each input party is able to obtain a limited number of evaluations of the share polynomial by using an oblivious pseudorandom function as the pseudorandom function.

5. The computer-processor-implemented method of claim 1, wherein the share polynomial of an input party includes a constant term randomly selected by the input party.

6. The computer-processor-implemented method of claim 1, wherein obtaining comprises:
receiving, from each input party of the multiple input parties, the share polynomial for the dataset of the input party.

7. The computer-processor-implemented method of claim 1, wherein obtaining comprises:
receiving, from each input party of the multiple input parties, a first share polynomial for each dataset of the input party and a second share polynomial for each dataset of the input party;
determining an intersection polynomial comprises:
computing the intersection polynomial as the greatest common divisor of a sum of the first share polynomials of each input party and a sum of the second share polynomials of each input party, and
determining the private set intersection of the datasets comprises:
factorizing the intersection polynomial into linear factors using equal-degree factorization.

8. A computing system corresponding to a third party for computing a private set intersection of datasets of multiple input parties, wherein each dataset includes one or more data elements, the computing system comprising:
one or more hardware processors;
memory;
a share of zero processor storable in memory, executable by the one or more hardware processors, and configured to obtain one or more share polynomials for each dataset of the multiple input parties, the one or more share polynomials for a dataset of an input party being encoded from shares of zero for the input party, each share of zero corresponding to a data element of the dataset of the input party;
an intersection polynomial generator storable in memory, executable by the one or more hardware processors, and configured to determine an intersection polynomial based on the one or more share polynomials; and
an intersection solver storable in memory, executable by the one or more hardware processors, and configured to determine the private set intersection of the datasets to include data elements of the datasets of the multiple input parties for which the intersection polynomial of the multiple input parties solves to zero.

9. The computing system of claim 8, wherein the share of zero for each data element of a dataset of an input party is computed based on pseudorandom function keys corresponding to pairs of distinct input parties of the multiple input parties, each pseudorandom function key being unique relative to other pseudorandom function keys of the multiple input parties and being shared from a sending input party to a receiving input party.

10. The computing system of claim 9, wherein the share of zero for each data element in the dataset of an input party is computed by the input party as a sum of evaluations of a pseudorandom function at the data element and each pseudorandom function keys for which it is the sending input party minus a sum of evaluations of a pseudorandom function at the data element and each pseudorandom function keys for which it is the receiving input party.

11. The computing system of claim 10, wherein each input party is able to obtain a limited number of evaluations of the share polynomial by using an oblivious pseudorandom function as the pseudorandom function.

12. The computing system of claim 8, wherein the share polynomial of an input party includes a constant term randomly selected by the input party.

13. The computing system of claim 8, wherein the share of zero processor is configured to receive, from each input party of the multiple input parties, the share polynomial for the dataset of the input party.

14. The computing system of claim 8, wherein the share of zero processor is configured to receive, from each input party of the multiple input parties, a first share polynomial for each dataset of the input party and a second share polynomial for each dataset of the input party, the intersection polynomial generator is configured to compute the intersection polynomial as the greatest common divisor of a sum of the first share polynomials of each input party and a sum of the second share polynomials of each input party, and the intersection solver is configured to determine the private set intersection of the datasets includes factorizing the intersection polynomial into linear factors using equal-degree factorization.

15. One or more tangible processor-readable storage media embodied with instructions for executing on one or more processors and circuits of a computing device a process for computing, by a third party, a private set intersection of datasets of multiple input parties, wherein each dataset includes one or more data elements, the process comprising:
obtaining one or more share polynomials for each dataset of the multiple input parties, the one or more share polynomials for a dataset of an input party being encoded from shares of zero for the input party, each share of zero corresponding to a data element of the dataset of the input party;
determining an intersection polynomial based on the one or more share polynomials; and
determining the private set intersection of the datasets to include data elements of the datasets of the multiple input parties for which the intersection polynomial of the multiple input parties solves to zero.

16. The one or more tangible processor-readable storage media of claim 15, wherein the share of zero for each data element of a dataset of an input party is computed based on pseudorandom function keys corresponding to pairs of distinct input parties of the multiple input parties, each pseudorandom function key being unique relative to other pseudorandom function keys of the multiple input parties and being shared from a sending input party to a receiving input party.

17. The one or more tangible processor-readable storage media of claim 16, wherein the share of zero for each data element in the dataset of an input party is computed by the input party as a sum of evaluations of a pseudorandom function at the data element and each pseudorandom function keys for which it is the sending input party minus a sum of evaluations of a pseudorandom function at the data element and each pseudorandom function keys for which it is the receiving input party.

18. The one or more tangible processor-readable storage media of claim 17, wherein each input party is able to obtain a limited number of evaluations of the share polynomial by using an oblivious pseudorandom function as the pseudorandom function.

19. The one or more tangible processor-readable storage media of claim 15, wherein obtaining comprises:
receiving, from each input party of the multiple input parties, the share polynomial for the dataset of the input party.

20. The one or more tangible processor-readable storage media of claim 16, wherein obtaining comprises:
receiving, from each input party of the multiple input parties, a first share polynomial for each dataset of the input party and a second share polynomial for each dataset of the input party, determining an intersection polynomial comprises:
computing the intersection polynomial as the greatest common divisor of a sum of the first share polynomials of each input party and a sum of the second share polynomials of each input party, and
determining the private set intersection of the datasets comprises:
factorizing the intersection polynomial into linear factors using equal-degree factorization.
